(19) United States
(12) Patent Application Publication
(10) Pub. No.: US 2015/0228984 A1
(43) Pub. Date: Aug. 13, 2015

(54) AIR-BREATHING CATHODE FOR METAL-AIR BATTERIES

(71) Applicant: JOHNSON MATTHEY PUBLIC LIMITED COMPANY, London (GB)

(72) Inventors: Sarah Caroline Ball, Oxon (GB); Robert John Potter, Berkshire (GB); Jonathan David Brereton Sharman, Berkshire (GB)

(21) Appl. No.: 14/419,346

(22) PCT Filed: Aug. 1, 2013
(86) PCT No.: PCT/GB2013/052066

§ 371 Date: Feb. 3, 2015

(30) Foreign Application Priority Data
Aug. 3, 2012 (GB) 1213832.7

(51) Int. Cl. H01M 4/90; H01M 12/08

(52) U.S. Cl. CPC H01M 4/9016; H01M 12/08; H01M 2004/8689

(57) ABSTRACT

An air-breathing cathode includes
(i) a conductive current collector;
(ii) a metal-ion conducting medium;
   and a metal oxide of formula

(AA′)ₐ(BB′)_{b}O_{c}.

wherein:
A and A′ are the same or different and selected from RE (which is yttrium, lanthanum, cerium, praseodymium, neodymium, promethium, samarium, europium, gadolinium, terbium, dysprosium, holmium, erbium, thulium, ytterbium, lutetium), magnesium, calcium, strontium, barium, lithium, sodium, potassium, indium, thallium, tin, lead, antimony or bismuth;
B is Ru, Ir, Os, Rh, Ti, Sn, Ge, Mn, Ta, Nb, Mo, W, Zr or Pb; B′ is absent or selected from Ru, Ir, Os, Rh, Ca, Mg, In, Tl, Sn, Pb, Sb, Bi, Ge, Ta, Nb, Mo, W, Zr or RE;
c is from 3-11;
the atomic ratio of (a+b):c is from 1:1 to 1:2;
the atomic ratio of a:b is from 1: 1.5 to 1.5:1 and at least one A and/or A′ is an alkali metal, alkaline earth metal or RE.

The present invention relates to a cathode and in particular to an air-breathing cathode for use in a metal-air battery.

Energy storage, especially for transport applications, remains one of the major technology challenges for the 21^{st} century. Lithium-ion battery technology has played an important role powering portable devices. However, even the most advanced lithium-ion batteries for portable applications are reaching the limit of their practical capabilities and do not meet the requirements for transportation. Although a number of different battery systems exist, their lower theoretical energy densities make them less attractive for the electric vehicle (EV) market and they all have major technical challenges. Metal-air batteries, and in particular, lithium-air batteries, present the prospect of achieving the highest energy density possible for a practical, rechargeable battery. If the atomic mass of lithium alone is taken into consideration, a theoretical specific energy of around 13,000 Wh/kg may be calculated which is similar to the theoretical energy density of gasoline (13,200 Wh/kg). More realistic calculations that include the weight of oxygen, electrolyte and other cell components, still indicate a 3-5 fold improvement in specific capacity is achievable for lithium-air battery systems compared with current and near term lithium-ion battery technology.

A lithium-air battery essentially comprises a lithium-containing anode, an electrolyte and an air-breathing cathode. Lithium is oxidised at the anode forming lithium ions and electrons. The electrons flow through an external circuit and the lithium ions migrate across an electrolyte to the cathode where oxygen is reduced to form lithium oxides, such as Li₂O₂. The battery is recharged by applying an external potential; lithium metal is plated on the anode and oxygen is generated at the cathode. Lithium-air batteries can be classified into four different architectures depending on the type of electrolyte used: aprotic, aqueous, mixed aprotic/aqueous and solid state.

The aprotic cell design uses any liquid organic electrolyte capable of solvating lithium ion salts (e.g. LiPF₆, LiAsF₆, LiN(SO₂CF₃)₂ and LiSO₃CF₃), but have typically consisted of carbonates, ethers and esters. An advantage of using an aprotic electrolyte is that an interface between the anode and electrolyte is spontaneously formed which protects the lithium metal from further reaction with the electrolyte. Typically a liquid electrolyte filled porous separator is used to prevent physical contact and shorting between the anode and cathode. A solid polymer electrolyte may also be used, wherein lithium salts are dispersed in a polymer matrix capable of solvating the cations. Such polymers may also be pre-formed then swelled with the lithium-containing liquid electrolytes to improve conductivity or combined with liquid electrolytes or other plasticisers to form gel-polymer electrolytes. If the polymer is sufficiently robust a porous separator is not required, but reinforcement materials, such as a microporous web or fibres of a fluoropolymer such as PTFE as described in U.S. Pat. No. 6,254,978, EP 0814897 and U.S. Pat. No. 6,110,330, or polyvinylidene fluoride (PVDF), or alternative materials such as PEEK or polyethylene, may be incorporated into the polymer/gel. These various aprotic electrolytes may also be incorporated into the electrode structures to improve ionic conductivity. A problem associated with the use of an aprotic electrolyte is that the lithium oxides produced at the cathode are generally insoluble in the aprotic electrolyte leading to build up of the lithium oxides along the cathode/electrolyte interface. This can make cathodes in aprotic cells prone to clogging and volume expansion which reduces conductivity and degrades battery performance over time.

The aqueous cell design uses an electrolyte which is a combination of lithium salts dissolved in water, for example aqueous lithium hydroxide (alkali). The aqueous electrolyte could also be acidic. The problem of cathode clogging is avoided since the lithium oxides formed at the cathode are water soluble, which allows aqueous lithium-air batteries to maintain their performance overtime. The aqueous cell also has a higher practical discharge potential than a cell using an aprotic electrolyte. A major problem, however, is that lithium reacts violently with water and therefore a solid electrolyte interface is required between the lithium metal and the aqueous electrolyte. The solid electrolyte interface is required to be lithium ion conducting, but the ceramics and glasses currently used only demonstrate low conductivities.

A mixed cell design uses an aprotic electrolyte adjacent to the anode and an aqueous electrolyte adjacent to the cathode, the two different electrolytes being separated by a lithium ion conducting membrane.

The solid-state design would appear attractive as it overcomes the problems at the anode and cathode when an aprotic or aqueous electrolyte is used. The anode and cathode are separated by a solid material. Such materials include glass ceramics such as lithium-aluminium-titanium-phosphate (LATP), lithium-aluminium-germanium-phosphate (LAGP) and silica doped versions, ceramic oxides with garnet type structures such as lithium-lanthanum-M oxides (M=Zr, Nb, Ta etc), perovskites such as lithium-lanthanum-titanates and other framework oxides including NASICON type structures (such as Na₃Zr₂PSi₂O₁₂). The main disadvantage of the solid-state design is the low conductivity of the glass-ceramic electrolyte.

Using an aprotic electrolyte is preferred to date, despite the disadvantages outlined above, because it currently provides substantially higher cell capacity.

Although the theoretical energy density of a lithium-air battery exceeds 5000 Wh/kg, the actual values obtained so far fall well short of this theoretical value. It is generally accepted that the performance limitations of lithium-air batteries are related to the air cathode. Although the cathode reaction provides most of the cell energy, the majority of the cell voltage drop also occurs at the cathode. At the cathode, a three-phase interface is required between Li⁺ ions/O₂/e⁻. Lithium oxides are formed as a result of the cathode reaction and in an aprotic electrolyte system, these oxides are insoluble. It is believed that these insoluble oxides form a barrier on the surface of the cathode and can block the cathode pore structure and prevent Li⁺ ions and O₂ from reaching the reaction sites, thus terminating the discharge prematurely. These oxides also have reduced electrical conductivity compared with the cathode which also limits the reaction rate and reduces discharge voltage.

A further problem with current lithium-air batteries is that such cells exhibit large overvoltages, i.e. the voltage required to recharge the battery is considerably higher than the voltage required to discharge the battery. This results in a low cycle energy efficiency of around 60-70%; for a viable battery, a cycle energy efficiency of over 90% is desirable.

It is the object of the present invention to provide an improved air-breathing cathode for use in metal-air batteries, in particular in lithium-air batteries, and specifically to provide an improved air-breathing cathode that demonstrates a lower overvoltage during recharging and a higher voltage during discharging. Accordingly, the present invention provides an air-breathing cathode, suitable for use in a metal-air battery, comprising
(i) a conductive current collector; and
(ii) a metal-ion conducting medium;
characterised in that the cathode further comprises a metal oxide of formula

(AA′)ₐ(BB′)_{b}O_{c}.

wherein:
A and A′ are the same or different and are selected from the group consisting of RE (wherein RE is selected from yttrium, lanthanum, cerium, praseodymium, neodymium, promethium, samarium, europium, gadolinium, terbium, dysprosium, holmium, erbium, thulium, ytterbium, lutetium), magnesium, calcium, strontium, barium, lithium, sodium, potassium, indium, thallium, tin, lead, antimony and bismuth;
B is selected from the group consisting of Ru, Ir, Os, Rh, Ti, Sn, Ge, Mn, Nb, Ta, Mo, W, Zr and Pb;
B′ is absent or is selected from the group consisting of Ru, Ir, Os, Rh, Ca, Mg, In, Tl, Sn, Pb, Sb, Bi, Ge, Nb, Ta, W, Mo, Zr or RE (wherein RE is as hereinbefore defined);
c is from 3-11;
the atomic ratio of (a+b):c is from 1:1 to 1:2;
the atomic ratio of a:b is from 1: 1.5 to 1.5:1.

In some embodiments, it may be preferable that lithium is excluded from the list of suitable elements for A and A′. In some embodiments, it may be preferable that Nb, Ta, Mo, W and Zr are excluded from the list of suitable elements for B. In some embodiments, it may be preferable that Nb, Ta, Mo, W and Zr are excluded from the list of suitable elements for B′.

Preferably, at least one of A and A′ is an alkali metal, an alkaline earth metal or RE. More preferably, A is an alkali metal or an alkaline earth metal and A′ is an alkaline earth metal or RE. Still more preferably, A is an alkali metal and A′ is an alkaline earth metal or RE.

Suitably A and A′ are selected from the group consisting of: RE, lithium, sodium, potassium, magnesium, calcium, strontium, barium, lead and cerium; preferably, lithium, sodium, potassium, magnesium, calcium, strontium, barium, lead, cerium, praseodymium and terbium. In some embodiments, it may be preferable that lithium, magnesium and/or lead is excluded from the list of suitable elements for A and A′.

It is particularly suitable that A and A′ are selected from sodium, potassium, calcium, strontium and cerium. For example, A may be selected from sodium and potassium (most preferably sodium), and A′ may be selected from calcium and cerium.

Suitably, B is selected from the group consisting of: Ru, Ir, Os, Rh and Ti; preferably Ru, Ir and Ti.

Suitably, B′ is selected from the group consisting of Ru, Ir, Os, Rh, Ca, Mg, RE, In, Tl, Sn, Pb, Sb, Bi and Ge; preferably Ru, Ir, Ca, Mg, RE, In, Tl, Sn, Pb, Sb, Bi and Ge. In some preferred embodiments, B′ is absent.

c is from 3-11. Since the atomic ratio of (a+b):c is known, the value of (a+b) can be determined. Similarly, since the atomic ratio of a:b and the value of (a+b) is known, the values of a and b can be determined.

The metal oxide may be crystalline, amorphous or a mixture thereof.

In a first embodiment of this invention, the cathode comprises a metal oxide of formula (AA′)ₐ(BB′)O_{c}. In this formula: A, A′, B and B′ are as hereinbefore defined; a is 0.66 to 1.5, b is 1 and c is 3 to 5. These metal oxides have a perovskite type structure, as described in Structural Inorganic Chemistry: Fifth Edition, Wells, A. F., Oxford University Press, 1984 (1991 reprint). Specific examples of metal oxides with a perovskite type structure include, but are not limited to, RERuO₃; SrRuO₃; PbRuO₃; REIrO₃; CaIrO₃; BaIrO₃; PbIrO₃; SrIrO₃; KIrO₃; SrM_{0.5}Ir_{0.5}O₃ (wherein M is Ca, Mg or RE, (wherein RE is as hereinbefore defined)).

In a second embodiment of this invention, the cathode comprises a metal oxide of formula (AA')ₐ(BB')₂O_{c}. In this formula: A, A′, B and B′ are as hereinbefore defined; a is 1.33 to 3, b is 2 and c is 3 to 10, preferably 6 to 7. These metal oxides have a pyrochlore type structure, as described in Structural Inorganic Chemistry: Fifth Edition, Wells, A. F., Oxford University Press, 1984 (1991 reprint). Specific examples of metal oxides with a pyrochlore type structure include, but are not limited to, RE₂Ru₂O₇; RE₂Ir₂O₇; Bi₂Ir₂O₇; Pb₂Ir₂O₇; Ca₂Ir₂O₇ (wherein RE is as hereinbefore defined).

In a third embodiment of this invention, the cathode comprises a metal oxide of formula (A_{0.33}A′_{0.66})₂(BB′)₂O_{c}. In this formula: A is Na; A′ is RE, B is Ti, Sn, Ge, Ru, Mn, Ir, Os or Pb; B′ is absent or is Ti, Sn, Ge, Ru, Mn, Ir, Os or Pb; a is 2, b is 2 and c is 6 to 7. These metal oxides also have a pyrochlore type structure as described above.

In a fourth embodiment of this invention, the cathode comprises a compound of formula (AA′)ₐ(BB′)₃O₃. In this formula: A, A′, B and B′ are as hereinbefore defined; a is 2 to 4.5, b is 3 and c is 10 to 11. These metal oxides have a KSbO₃ type structure, as described as a cubic form with space group Pn3 in Structural Inorganic Chemistry: Fifth Edition, Wells, A. F., Oxford University Press, 1984 (1991 reprint). Specific examples of metal oxides with a KSbO₃ type structure include, but are not limited to, K₃Ir₃O₉; Sr₂Ir₃O₉; Ba₂Ir₃O₉; La₃Ir₃O₁₁.

In some of these compositions listed above, there may be oxygen vacancies which will reduce the oxygen stoichiometry in the structure. Similarly, some of the one or more first metal sites (or A, A′ sites) may be left vacant, reducing the stoichiometry of the first metal (or A, A′ metal) in the structure. Furthermore, in some instances, water molecules are known to occupy some vacant sites to provide a hydrated or partially hydrated metal oxide.

In a particularly composition for the metal oxide of the air breathing cathode of the present invention:
A is Na;
A′ is RE;
B is Ti, Sn, Ge, Ru, Mn, Ir, Os, Ta, Nb, Mo, W Zr or Pb;
B′ is absent or is Ti, Sn, Ge, Ru, Mn, Ir, Os, Ta, Nb, Mo, W Zr or Pb;
a is 2;
b is 2; and
c is 6 to 7.

B may preferably be Ti, Sn, Ge, Ru, Mn, Ir, Os or Pb. B′ may preferably be Ti, Sn, Ge, Ru, Mn, Ir, Os or Pb.

In a further particularly preferred composition for the metal oxide of the air breathing cathode of the present invention,
A is Li, Na or K, preferably Na or K;
A′ is an alkaline earth element or RE, preferably calcium or cerium;
B is Ti, Sn, Ge, Ru, Mn, Ir, Os, Ta, Nb, Mo, W, Zr or Pb; and
B′ is absent or is Ti, Sn, Ge, Ru, Mn, Ir, Os, Ta, Nb, Mo, W, Zr or Pb.

In this preferred composition, preferably a is 2, b is 2, and c is 6 to 7. These preferred values for a, b and c may also be preferred for other compositions described herein. B may preferably be Ti, Sn, Ge, Ru, Mn, Ir, Os or Pb. B′ may preferably be Ti, Sn, Ge, Ru, Mn, Ir, Os or Pb.

The metal oxides assist in catalysing the recharging of the metal-air battery and may also assist in the discharge of the metal-air battery.

Preferably, the specific surface area (BET) of the metal oxide is greater than 20 m²/g, preferably greater than 50 m²/g. The determination of the specific surface area by the BET method is carried out by the following process: after degassing to form a clean, solid surface, a nitrogen adsorption isotherm is obtained, whereby the quantity of gas adsorbed is measured as a function of gas pressure, at a constant temperature (usually that of liquid nitrogen at its boiling point at one atmosphere pressure). A plot of 1/[Vₐ((P₀/P)−1)] vs P/P₀ is then constructed for P/P₀ values in the range 0.05 to 0.3 (or sometimes as low as 0.2), where Vₐ is the quantity of gas adsorbed at pressure P, and Pₒ is the saturation pressure of the gas. A straight line is fitted to the plot to yield the monolayer volume (Vₘ), from the intercept 1/VₘC and slope (C−1)/VₘC, where C is a constant. The surface area of the sample can be determined from the monolayer volume by correcting for the area occupied by a single adsorbate molecule. More details can be found in ‘Analytical Methods in Fine Particle Technology’, by Paul A. Webb and Clyde Orr, Micromeritics Instruments Corporation 1997.

The metal oxide can be made by a variety of routes, including solid state synthesis, hydrothermal synthesis, spray pyrolysis, flame spray pyrolysis and in some cases co-precipitation. The direct solid state synthesis route involves heating stoichiometric mixtures of oxides and/or carbonates in air to high temperature, typically >800° C. Hydrothermal synthesis involves heating mixtures of appropriate starting salts and if necessary an oxidising agent at a more modest temperature (typically 200-250° C.) in a suitable sealed vessel. This method generally gives materials with much higher surface area (i.e. smaller crystallite size) than those prepared by solid state routes.

The loading of metal oxides and thickness of the cathode is not particularly limited and will vary depending on the operational conditions used for the metal air battery and the porosity of the cathode. The loading of metal oxides may vary between 0.003 mg/cm² and 15 mg/cm², suitably between 0.005 mg/cm² and 5 mg/cm² and preferably between 0.005 mg/cm² and 1 mg/cm².

The conductive current collector in the air-breathing cathode of the invention should allow air/oxygen to diffuse through, and may be any suitable current collector known to those skilled in the art. Example of suitable conductive current collectors includes meshes or grids, for example of metal such as aluminium, stainless steel, titanium or nickel. The conductive current collector may also be a graphite plate with channels provided in one face through which air/oxygen can flow. The conductive current collector may also comprise a gas diffusion layer applied to one face thereof. Typical gas diffusion layers are suitably based on conventional non-woven carbon fibre gas diffusion substrates such as rigid sheet carbon fibre papers (e.g. the TGP-H series of carbon fibre papers available from Toray Industries Inc., Japan) or roll-good carbon fibre papers (e.g. the H2315 based series available from Freudenberg FCCT KG, Germany; the Sigracet® series available from SGL Technologies GmbH, Germany; the AvCarb® series available from Ballard Material Products, United States of America; or the NOS series available from CeTech Co., Ltd. Taiwan), or on woven carbon fibre cloth substrates (e.g. the SCCG series of carbon cloths available from the SAATI Group, S.p.A., Italy; or the WOS series available from CeTech Co., Ltd, Taiwan).

In one embodiment of the invention, the air-breathing cathode further comprises a porous conductive material. The porous conductive material in the air-breathing cathode of the invention is not particularly limited provided it is porous and conductive. Examples include carbon black such as ketjen black, acetylene black; graphite, such as natural graphite; conductive fibres, such as carbon fibres and metal fibres, powders of a metal such as copper, silver, nickel or aluminium; carbon nanotubes or arrays of carbon nanotubes; organic conductive materials such as polyphenylene derivatives, polypyrrole and polyaniline and materials that are conducting once carbonised such as polyvinylpyrollidone and polyacrilonitrile ; or a mixture of one or more of these. Although a high surface area and pore volume will lead to a large theoretical capacity, small porosity may be inaccessible to electrolyte/O₂ or become rapidly blocked during the discharge reaction; therefore materials with porosity in the mesopore region (i.e. between 2 and 50 nm) are beneficial. The porous conductive material is present in the air-breathing cathode at a loading of 1 to 99 wt % based on the total weight of the metal oxide and the porous conductive material, suitably from 50 to 99 wt %, and preferably from 70 to 95 wt %. The metal oxides may be supported on the porous conductive material of the air-breathing cathode or very intimately mixed with the porous conductive material.

In one embodiment of the invention, the porous conductive material has oxygen reduction activity and will assist in reducing the oxygen at the cathode. Examples of such materials include high surface area carbons such as Super P (TIMCAL), XC-72R (CABOT) ketjen EC300J (Akzo Nobel) and graphitised or functionalised carbon supports. The air-breathing cathode of this embodiment may optionally comprise a further oxygen reduction catalyst as described hereinafter.

The metal oxides are suitably present in the air-breathing cathode at a loading of 1 to 99 wt % based on the total weight of the metal oxide and the porous conducting material, suitably from 1 to 50 wt % and preferably from 5 to 30 wt %.

In a further embodiment of the invention, the air-breathing cathode further comprises an oxygen reduction catalyst. Examples of the oxygen reduction catalyst suitable for use in the air-breathing cathode of the invention will be known to those in the art and include, but are not limited to, inorganic oxides (e.g. MnO₂, TiO₂, Co₃O₄, Fe₃O₄, NiFe₂O₄), perovskites, precious metal catalysts. The oxygen reduction catalyst is optionally supported on a high surface area support material, such as carbon or other supports and the ‘support’ itself can also have activity for the oxygen reduction reaction. The support may be the porous conductive material in the air-breathing cathode of the invention.

The metal-ion conducting medium in the air-breathing cathode of the invention may be any of the liquid or solid electrolyte materials previously described dispersed throughout the cathode such that good lithium ion mobility, O₂ access and electrical conductivity are maintained. Suitably, the metal-ion conducting medium is lithium-ion conducting. For example, a lithium salt is dissolved/dispersed in a suitable aprotic liquid, water or solid electrolyte material, such as a solid polymer electrolyte or a solid glass ceramic material. Suitable lithium salts include, but are not limited to: lithium perchlorate (LiClO₄), lithium hexafluoro phosphate (LiPF₆), lithium bis(trifluoromethanesulphonyl)imide (LiTFSI), lithium bis(pentafluoroethane sulphonyl)imide (LiBETI), lithium 4-5-dicyano-2-trifluromethyl imidazole (LiTDI). Suitable aprotic liquids include, but are not limited to: carbonates (such as propylene carbonate (PC), dimethyl carbonate (DMC), diethylcarbonate, ethylene carbonate (EC)) or ethers/glymes (such as dimethyl ether (DME) and tetraglyme) or ionic liquids (such as 1-ethyl-3-methylimidazolium-bis(trifluoromethylsulfonyl)imide (EMITF SI), N-methyl-N-proopylpiperidinium bis(trifluoromethanesulfonyl)imide (PP13-TFSI)). Suitable solid polymer electrolyte materials include, but are not limited to, polymers which may contain oxygen, nitrogen, fluorine or sulphur donor atoms in the polymer chain to solvate the cations, such as polyethylene oxide (PEO), polyamine and polysulphides or other polymers such as polyvinylidine fluoride PVDF or copolymers such as poly(vinylidine fluoride-hexafluoropropylene) (PVDF-HFP). A gel-polymer electrolyte may also be produced by combining these liquid electrolyte and solid polymer components and/or addition of a plasticiser (such as PC, ethylene carbonate, borate derivatives with poly(ethylene glycol) B-PEG) to the polymer. The metal-ion conducting medium is present in the air-breathing cathode at a loading of 10-800wt %, suitably 100-400wt % based on the total weight of the metal oxide and porous conductive material. The present inventors have found that the air breathing cathode of the present invention functions well where the metal-ion conducting medium is an aprotic liquid. However in some preferred embodiments a solid electrolyte may be employed.

The air-breathing cathode of the invention may also comprise a binder. The binder may be selected from the group consisting of polyethylene, polypropylene, polytetrafluoroethylene (PTFE), polyvinylidenefluoride (PVDF), styrene-butadiene rubber, tetrafluoroethylene-hexafluoroethylene (PTFE-HFP) copolymer, polyvinylidenefluoride-hexafluoropropylene copolymer (PVDF-HFP), tetrafluoroethylene-perfluoroalkyl vinyl ether copolymer, vinylidene fluoride-hexafluoropropylene copolymer, vinylidene fluoride-chlorotrifluoroethylene copolymer, ethylene-tetrafluoroethylene copolymer, polychlorotrifluoroethylene, vinylidene fluoride-pentafluoropropylene copolymer, propylene-tetrafluoroethylene copolymer, ethylene-chlorotrifluoroethylene copolymer, vinylidene fluoride-hexafluoropropylene-tetrafluoroethylene copolymer, vinylidene fluoride-perfluoromethyl vinyl ether-tetrafluoroethylene copolymer, ethylene-acrylic acid copolymer or a mixture thereof. Specific examples include PVDF, PVDF-HFP and perfluorinated sulphonic acid (e.g. Nafion) and lithium-exchanged PFSAs. The binder may be present in the air-breathing cathode at a loading of 10-100 wt % with respect to the total weight of the metal oxide and porous conducting material.

The air-breathing cathode of the invention may be made by mixing the metal-ion conducting medium, and the metal oxide in a suitable polar solvent (e.g. acetone, NMP, DEK, DMSO, water, alcohols, ethers and gycol ethers and organic carbonates) and either casting as a free standing film or coating onto the conductive current collector. If present, porous conductive material, the oxygen reduction catalyst and/or the binder are also mixed in with the polar solvent. Casting a free-standing film or coating onto the conductive current collector may be carried out by K-bar coating, doctor blade, screen printing, spraying or brush coating or dip coating. In one embodiment, the free standing film is first cast onto a transfer release substrate, such as PTFE, or glass sheet and is then subsequently transferred and affixed to the conductive current collector by lamination via hot pressing or cold pressing. The air breathing-cathode layer may also be applied directly onto a solid polymer or other solid electrolyte layer by various techniques including those described above. The air breathing cathode may also be cast or coated directly onto a solid Li conducting electrolyte, such as a polymer, glass or ceramic free standing film.

Alternatively, the air-breathing cathode of the invention may be made by mixing the metal oxide in a suitable polar solvent (e.g. acetone, NMP, DEK, DMSO, water, alcohols, ethers and gycol ethers and organic carbonates) and either casting as a free standing film or coating onto the conductive current collector. If present, porous conductive material, the oxygen reduction catalyst and/or the binder are also mixed in with the polar solvent. The metal-ion conducting medium is then applied to the free-standing film or coating so that it impregnates into the free-standing film or coating. The free standing film is then transferred to the current collector by methods described above.

A further aspect of the invention provides a metal-air battery comprising an air-breathing cathode according to the present invention, an anode and an electrolyte separating the anode and cathode.

The anode comprises an anode layer having an active anode material and an anode current collector. The active anode material suitably comprises a metal element capable of absorbing and releasing metal ions. Examples of the metal element include, but are not limited to, the alkali metals (e.g. Na, Li, K), alkaline earth metals (e.g. Mg, Ca), amphoteric metals (e.g. Zn, Al, Si) and transition metals (e.g. Fe, Sn, Ti, Nb, W). Preferably, the metal element is an alkali metal, in particular lithium. The metal element is present as the metal, an alloy (e.g. with tin or silicon), an oxide, a nitride, a sulphide, carbide or as in intercalation product with e.g. carbon, silicon etc. Preferably, the metal element is present as the metal. Other materials commonly used in lithium ion battery technology such as Li₅Ti₄O₁₂, silicon, graphites, carbon nano-tubes, lithium metal or lithium metal alloys may also be used. The anode current collector is not particularly limited, provided that the material is conductive. Examples may include a metal, alloy, carbon etc and may be in the form of a foil, mesh, grid etc. Suitable anode current collectors would be known to the skilled person.

The electrolyte may be aprotic, aqueous, mixed or a solid and may be of any material provided it has the capability of conducting metal ions.

In one embodiment, the electrolyte is aprotic wherein a lithium salt is dissolved in a suitable aprotic liquid. Suitable lithium salts include, but are not limited to: lithium perchlorate (LiClO₄), lithium hexafluoro phosphate (LiPF₆), lithium bi s(trifluoromethanesulphonyl)imide (LiTF SI), lithium bis(pentafluoroethane sulphonyl)imide (LiBETI), lithium 4-5-dicyano-2-trifluromethyl imidazole (LiTDI). Suitable aprotic liquids include, but are not limited to: carbonates (such as propylene carbonate (PC), dimethyl carbonate (DMC), diethylcarbonate, ethylene carbonate (EC)) or ethers/glymes (such as dimethyl ether (DME) and tetraglyme) or ionic liquids (such as 1-ethyl-3-methylimidazolium-bis(trifluoromethylsulfonyl)imide (EMITFSI), N-methyl-N-proopylpiperidinium bis(trifluoromethanesulfonyl)imide (PP13-TFSI)).

In a further embodiment, the electrolyte is an aqueous liquid, for example aqueous lithium hydroxide. Alternatively, the aqueous electrolyte is acidic. If an aqueous electrolyte is used, a solid electrolyte interface is required between the anode and the electrolyte to prevent reaction of the anode with the aqueous electrolyte.

When liquid electrolytes are used, such as an aprotic or aqueous electrolyte, a porous separator is required between the anode and cathode to prevent electrical shorting and the metal air battery is configured such that the porous separator is impregnated with the liquid electrolyte. Examples of separator materials include porous films of polyethylene (for example expanded polytetrafluoroethylene), polypropylene, woven or non-woven fabric or glass fibre, or combinations of these or other components as composites/multilayer structures.

In a still further embodiment, the electrolyte is a solid or gel. For example, the electrolyte may be a solid polymer material having lithium salts dissolved or dispersed therein. For example, a lithium salt such as lithium perchlorate (LiClO₄), lithium hexafluoro phosphate (LiPF₆), lithium bis(trifluoromethanesulphonyl)imide (LiTFSI), lithium bis(pentafluoroethane sulphonyl)imide (LiBETI), lithium 4-5-dicyano-2-trifluromethyl imidazole (LiTDI) is dissolved/dispersed in a polymer which contains oxygen, nitrogen, fluorine or sulphur donor atoms in the polymer chain to solvate the cations, such as polyethylene oxide (PEO), polyamine and polysulphides or other polymers such as polyvinylidine fluoride PVDF or copolymers such as poly(vinylidine fluoride-hexafluoropropylene) (PVDF-HFP). The polymer solution/dispersion is then cast to form an electrolyte membrane to be present in between the anode and cathode. Examples of gel electrolytes suitable or use in the present invention include, but not limited to, gel electrolytes composed of a polymer such as poly(vinylidene fluoride), poly(ethyleneglycol) or polyacrylonitrile; an amino acid derivative; or a saccharide such as a sorbitol derivative containing an electrolyte solution containing a lithium salt as hereinbefore described. If the polymer/gel is sufficiently robust a porous separator is not required, but reinforcement materials, such as a microporous web or fibres of a fluoropolymer such as PTFE as described in U.S. Pat. No. 6,254,978, EP 0814897 and U.S. Pat. No. 6,110,330, or polyvinylidene fluoride (PVDF), or alternative materials such as PEEK or polyethylene, may be incorporated into the polymer/gel.

In a yet further embodiment, the electrolyte is a solid glass ceramic material, for example lithium-aluminium-titanium-phosphate (LATP) , lithium-aluminium-germanium-phosphate (LAGP) and silica doped versions, ceramic oxides with garnet type structures such as lithium-lanthanum-M oxides (M=Zr, Nb, Ta etc), perovskites such as lithium-lanthanum-titanates and other framework oxides including NASICON type structures (such as Na₃Zr₂PSi₂O₁₂).

The present inventors have found that the air breathing cathode of the present invention functions well where the metal-ion conducting medium is an aprotic liquid. However in some preferred embodiments a solid electrolyte may be employed.

The metal-air battery may be constructed by techniques known to those in the art.

The metal-air batteries of the present invention may be used for portable, stationary or transport applications.

The invention will now be described further by way of example which is intended to be illustrative and not limiting. The Examples will be described with reference to the accompanying drawings, in which:

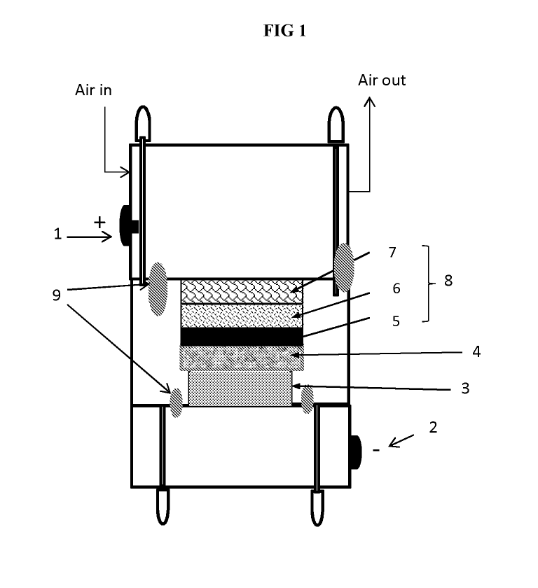

FIG. 1 shows a schematic diagram of a Swagelok cell incorporating a metal-air battery according to an embodiment of the invention.

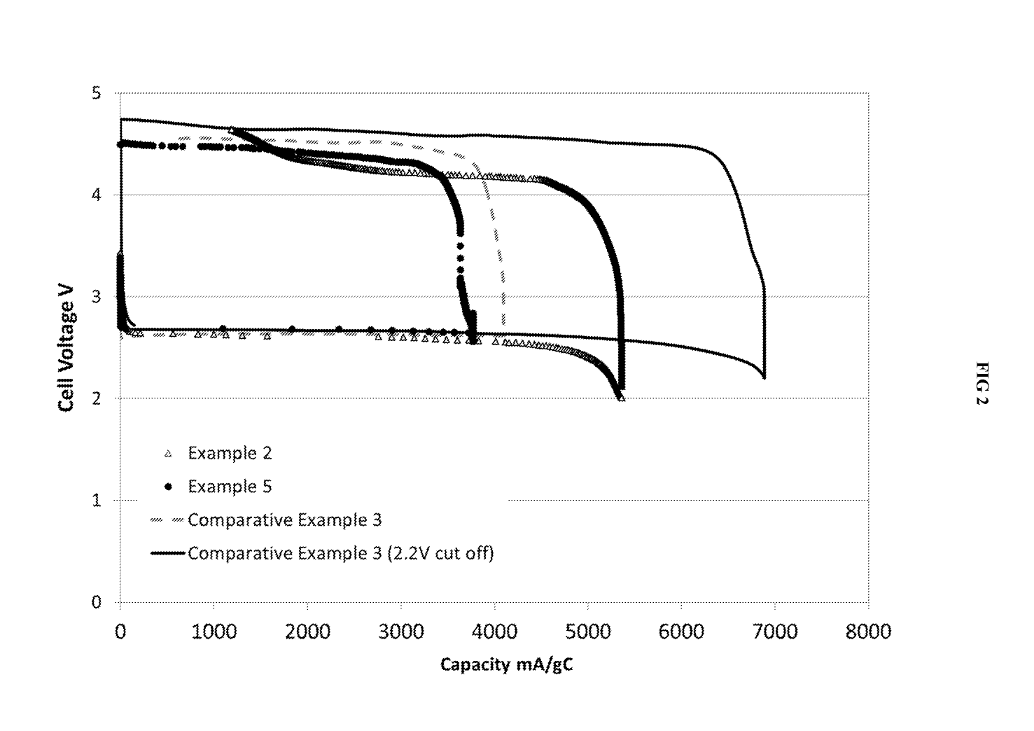

FIG. 2 shows a first discharge and charge at 80 mA/gC for Example 2, Example 5 and Comparative Example 3.

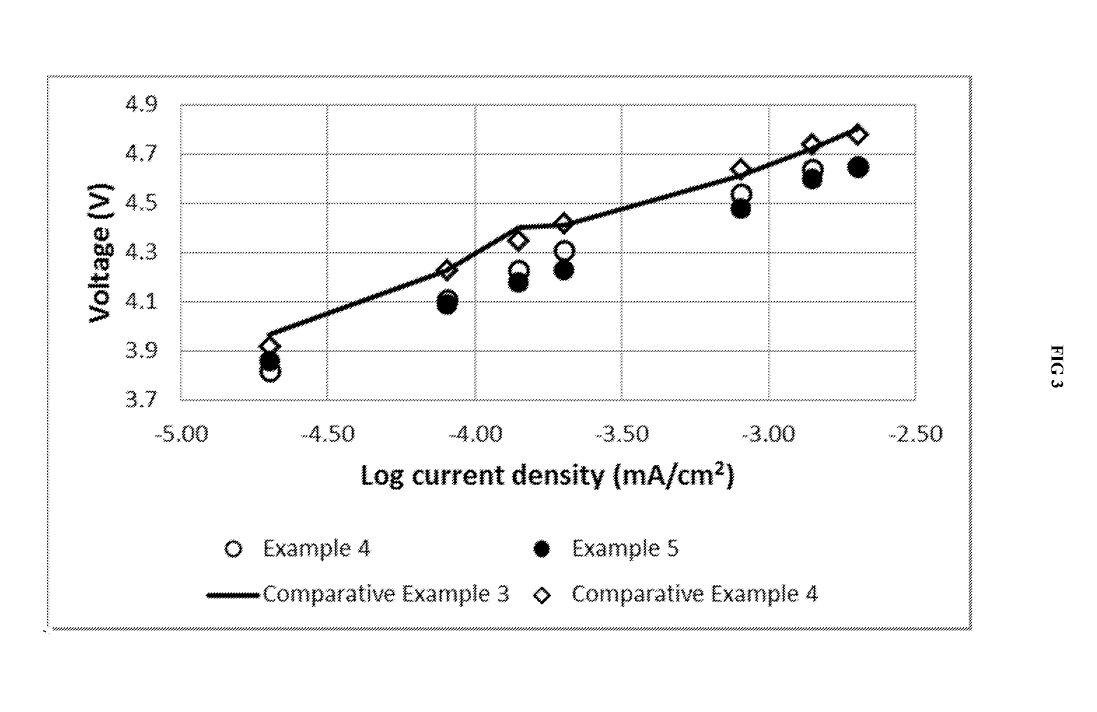

FIG. 3 shows cell voltage at steady 200-225 mAh/gC vs current density in the form of a Tafel plot for Example 4, Example 5, Comparative Example 3 and Comparative Example 4.

The porous conductive material, metal-ion conducting medium, metal oxide and binder were mixed in water in the case of Nafion binder or in acetone/NMP in the case of Kynarflex 2801 PVDF-HFP binder and coated onto Toray TGPH60 (available from Toray Industries) by either brush coating, screen printing or K-bar coating to form a cathode active layer. Electrodes were then dried in an oven under vacuum at between 80 and 120° C. The cathode current collector was stainless steel. The air-breathing cathode and the metal-air battery was constructed in situ in a Swagelok cell as depicted in FIG. 1.

The cell shown in FIG. 1 includes the following features, indicated by reference numbers in the Figure:

| | |
|---|---|
| 1 | Positive terminal |
| 2 | Negative terminal |
| 3 | Lithium metal |
| 4 | Separator |
| 5 | Cathode active layer |
| 6 | Toray TGPH60 |
| 7 | Cathode current collector |
| 8 | Cathode |
| 9 | O-rings |

The metal-air battery had an active area of 2 cm² defined by the 2 cm² lithium metal anode area. The anode and cathode were isolated from each other using a polypropylene separator filled with liquid electrolyte. The electrolyte solution was the same material as the metal-ion conducting medium used in the cathode. The separator and cathode electrode area were slightly larger such that the separator overlapped the anode and prevented any shorting. The cathode current collector was attached to a rod passing through the cell housing via an o-ring seal, so that the rod and cathode current collector could be moved towards the uncoated face of the Toray TGPH60 to ensure contact between all the components. Gas porting into and out of the cathode compartment allowed gases to be flowed through the air cathode and also the cell to be isolated from the external atmosphere. The cells were built in an Ar glove box (O₂ and H₂O<1ppm).

Battery single cells were tested using two different types of protocol. The first being prolonged discharge and charge at 80mA/gC to investigate cathode capacity and charge voltage and the second involving charging/discharging cycles under galvanostatic control in the current range 0.02-2.01 mA. The second experimental procedure was used to generate tafel slopes by plotting the cell voltage at steady state (200-225 mAh/gC) versus the logarithm of the current.

FIG. 2 shows results for discharge and charge of cathodes from Example 2, Example 5 and Comparative Example 3 at 80 mA/gC. FIG. 3 shows cell voltage at steady 200-225 mAh/gC vs current density in the form of a Tafel plot for Examples. Both data sets illustrate that the cathodes of the invention result in reduced charging voltages compared with Comparative Examples 3 and 4 (carbon only cathodes and carbon +Bi₂Ir₂O₇).

The Example batteries had the various components as shown in Table 1 below.

TABLE 1

| | | | Air-breathing Cathode | | | |
|---|---|---|---|---|---|---|
| | | | Porous | Metal-ion | | |
| | | | Conductive | Conducting | | |
| Example | Anode | Electrolyte | Material | medium | Metal Oxide | Binder |
| Example 1 | Lithium | LiTDI/ | XC72R | LiTDI/ | NaCaIrOₓ | Nafion |
| | metal | tetraglyme | (0.45 mgC/cm²) | tetraglyme | (0.22 mg/cm²) | (110 wt % |
| | | | | | | wrt C) |
| Example 2 | Lithium | LiTFSI/ | XC72R | LiTFSI/ | NaCaIrOₓ | Nafion |
| | metal | tetraglyme | (0.43 mgC/cm²) | tetraglyme | (0.2 mg/cm²) | (110 wt % |
| | | | | | | wrt C) |
| Example 3 | Lithium | LiTFSI/ | XC72R | LiTFSI/ | NaCeRuOₓ | Nafion |
| | metal | tetraglyme | | tetraglyme | | |
| Example 4 | Lithium | LiTFSI/ | Super P | LiTFSI/ | NaCaIrOₓ | Kynarflex |
| | metal | tetraglyme | (0.26 mgC/cm²) | tetraglyme | (0.05 mg/cm²) | 2801 |
| | | | | | | (41% wrt C) |
| Example 5 | Lithium | LiTFSI/ | Super P | LiTFSI/ | NaCeRuOₓ | Kynarflex |
| | metal | tetraglyme | (0.37 mgC/cm²) | tetraglyme | (0.07 mg/cm²) | 2801 |
| | | | | | | (41% wrt C) |
| Comparative | Lithium | LiTDI/ | XC72R | LiTDI/ | | Nafion |
| Example 1 | metal | tetraglyme | (0.41 mgC/cm²) | tetraglyme | | (75 wt % |
| | | | | | | wrt C) |
| Comparative | Lithium | LiTDI/ | XC72R | LiTDI/ | | Nafion |
| Example 2 | metal | propylene | (0.43 mgC/cm²) | propylene | | |
| | | carbonate | | carbonate | | |
| Comparative | Lithium | LiTFSI/ | Super P | LiTFSI/ | | Kynarflex |
| Example 3 | metal | tetraglyme | (0.23 to | tetraglyme | | 2801 |
| | | | 0.37 mgC/cm²) | | | (20% wrt C) |
| Comparative | Lithium | LiTFSI/ | Super P | LiTFSI/ | Bi₂Ir₂O₇ | Kynarflex |
| Example 4 | metal | tetraglyme | (0.2 mgC/cm²) | tetraglyme | (0.04 mg/cm²) | 2801 |
| | | | | | | (42% wrt C) |

The materials were obtained from the following sources:

Lithium metal anode: Sigma-Aldrich

Polypropylene separator: Hollingsworth & Vose Company

XC72R: CABOT Corporation

Super P: TIMCAL

LiTFSI/tetraglyme: LiTFSI salt and tetraglyme from Sigma-Aldrich

LiTDI/tetraglyme: LiTDI salt and tetraglyme from Sigma-Aldrich

LiTDI/propylene carbonate: LiTDI salt and propylene carbonate from Sigma-Aldrich

The electrolytes were prepared in house by drying the solvents over molecular sieves and transferring to an Argon glove box, then dispersing the Li salt in the solvent at the appropriate concentrations

NaCaIrOₓ (specifically Na_{0.54}Ca_{1.18}Ir₂O₆.0.66H₂O): Prepared according to Example 1 of International Patent Application No. PCT/GB2011/052472.

NaCeRuOₓ(specifically Na_{0.66}Ce_{1.34}Ru₂O₇): Prepared according to Example 5 of International Patent Application No. PCT/GB2011/052472.

Bi₂Ir₂O₇: Prepared according to Example 2 of International Patent Application No. PCT/GB2011/052472.

Nafion: DuPont de Nemours

Kynarflex 2801 (PVDF-HFP copolymer): Arkema Inc

1-20. (canceled)

21. An air-breathing cathode comprising
(i) a conductive current collector; and
(ii) a metal-ion conducting medium;
characterised in that the cathode further comprises a metal oxide of formula
(AA′)ₐ(BB′)_{b}O_{c}.
having a pyrochlore-type structure
wherein:
A and A′ are the same or different and are selected from the group consisting of RE (wherein RE is selected from yttrium, lanthanum, cerium, praseodymium, neodymium, promethium, samarium, europium, gadolinium, terbium, dysprosium, holmium, erbium, thulium, ytterbium, lutetium), magnesium, calcium, strontium, barium, lithium, sodium, potassium, indium, thallium, tin, lead, antimony and bismuth;
B is selected from the group consisting of Ru, Ir, Os, Rh, Ti, Sn, Ge, Mn, Ta, Nb, Mo, W, Zr and Pb;
B′ is absent or is selected from the group consisting of Ru, Ir, Os, Rh, Ca, Mg, In, Tl, Sn, Pb, Sb, Bi, Ge, Ta, Nb, Mo, W, Zr or RE (wherein RE is as hereinbefore defined);
c is from 3-11;
the atomic ratio of (a+b):c is from 1:1 to 1:2;
the atomic ratio of a:b is from 1: 1.5 to 1.5:1
wherein at least one of A and A′ is selected from an alkali metal, an alkaline earth metal and RE and
wherein a is from 1.33 to 3, b is 2 and c is from 3 to 10.

22. The air-breathing cathode according to claim 21 wherein a is 2, b is 2 and c is from 6 to 7.

23. The air breathing cathode according to claim 21 wherein A is an alkali metal and A′ is selected from an alkaline earth metal and RE.

24. The air-breathing cathode according to claim 21 wherein A and A′ are selected from the group consisting of: RE, lithium, sodium, potassium, magnesium, calcium, strontium, barium, lead and cerium; preferably, lithium, sodium, potassium, magnesium, calcium, strontium, barium, lead, cerium, praseodymium and terbium.

25. The air-breathing cathode according to claim 24 wherein A and A′ are selected from sodium, potassium, calcium, strontium and cerium.

26. The air-breathing cathode according to claim 21 wherein B is selected from ruthenium, iridium and titanium.

27. The air-breathing cathode according to claim 21, wherein:
A is Na;
A′ is RE;
B is Ti, Sn, Ge, Ru, Mn, Ir, Os or Pb;
B′ is absent or is Ti, Sn, Ge, Ru, Mn, Ir, Os or Pb;
a is 2;
b is 2; and
c is 6 to 7.

28. The air-breathing cathode according to claim 21, wherein the air-breathing cathode further comprises a porous conductive material, wherein optionally (i) the metal oxide is supported on the porous conductive material, or (ii) the metal oxide is intimately mixed with the porous conductive material.

29. The air-breathing cathode according to claim 21, wherein the air-breathing cathode further comprises an oxygen reduction catalyst.

30. The air-breathing cathode according to claim 29, wherein the oxygen reduction catalyst is supported on a high surface area support material.

31. The air-breathing cathode according to claim 21, wherein the air-breathing cathode further comprises a binder.

32. A metal-air battery comprising an air-breathing cathode according to claim 21, an anode, and an electrolyte between the air-breathing cathode and the anode.

33. The metal-air battery according to claim 32, wherein the anode comprises an active anode material and an anode current collector, wherein active anode material comprises lithium.

34. The metal-air battery according to claim 32, wherein the electrolyte is aprotic.
